(19) United States
(12) Patent Application Publication
(10) Pub. No.: US 2016/0344154 A1
(43) Pub. Date: Nov. 24, 2016

(54) Fiber Laser Device

(71) Applicant: LILAS GMBH, Dortmund (DE)

(72) Inventors: Aleksei MIKHAILOV, Dortmund (DE); Vitalij LISSOTSCHENKO, Froendenberg (DE)

(21) Appl. No.: 14/906,195

(22) PCT Filed: Feb. 2, 2015
(86) PCT No.: PCT/EP2015/052068

§ 371 Date: Jan. 19, 2016

(30) Foreign Application Priority Data
Feb. 6, 2014 (DE) 10 2014 101 483.9
Aug. 28, 2014 (DE) 10 2014 112 397.2
Oct. 1, 2014 (DE) 10 2014 114 310.8

(51) Int. Cl. H01S 3/094

(52) U.S. Cl. CPC H01S 3/094019; H01S 3/094049; H01S 3/094084

(57) ABSTRACT

Fiber laser device, comprising at least one optical fiber (1) having a fiber core, which is composed of a laser-active material or comprises a laser-active material, wherein the optical fiber (1) is wound in the shape of a loop, as well as pump means (15) for optical pumping of the fiber core of the at least one optical fiber (1) with pump light (9), wherein the pump means (15) are designed such that the pump light (9) enters the at least one optical fiber (1) laterally from the outside during the operation of the fiber laser device.

The present invention relates to a fiber laser device according to the preamble of claim 1.

Definitions: In the direction of propagation of the laser radiation refers to the mean propagation direction of the laser radiation, in particular when the laser radiation is not a plane wave or at least partly divergent. Unless expressly stated otherwise, laser, light beam, partial beam or beam refers not to an idealized beam of geometric optics, but rather to a real light beam, such as a laser beam having not an infinitesimally small, but rather an extended beam cross section. Light refers not only to electromagnetic radiation in the visible spectral range, but the entire optical spectral range of electromagnetic radiation covered by the optics, from the VUV to the FIR.

A fiber laser device of the aforementioned type is known from U.S. Pat. No. 6,178,187 B1. The fiber laser described therein includes a fiber core that is doped with laser-active rare earth ions. Furthermore, a cladding of the optical fiber with a rectangular cross section is used. Pump light is introduced at one end of the cladding, with the pump light then being coupled during its propagation through the coiled loops of the optical fiber into the fiber core where laser radiation is then generated. The cladding with the rectangular cross-section ensures that different lasing modes are generated in the fiber core, so that the pump light can be converted more effectively.

Since the intensity of the pump light in long optical fibers is comparatively low in areas that are remote from the end of the optical fiber where the pump light is introduced, pumping is non-uniform over the length of the optical fiber. Furthermore, the cross-sectional area of the cladding is comparatively small, so that the attainable pump powers are comparatively small.

The problem underlying the present invention is to provide a fiber laser device of the aforementioned type that is capable of attaining high output power.

This is achieved according to the invention with a fiber laser device of the aforementioned type having the characterizing features of claim 1. The dependent claims relate to preferred embodiments of the invention.

According to claim 1, the pump means are designed such that the pump light enters the optical fiber laterally from the outside during the operation of the fiber laser device. By applying the pump light laterally, on the one hand, high-intensity pump light can be introduced into the fiber core along the entire length of the optical fiber. On the other hand, a large pump, power can be coupled into the fiber core, with a suitable design of the pump means, thereby creating a high-power fiber laser.

The pump means can be especially designed in such a way that during the operation of the fiber laser device a plurality of windings or loops of the optical fiber wound as a loop can be pumped at the same time. In this way, the pump means can distribute the pump light very effectively over long sections, in particular over the length of the optical fiber.

The pump means may include at least one, in particular a plurality of transfer means, into which the pump light is introduced during the operation of the fiber laser device and from which or in which the pump light is coupled into the optical fiber. The pump power coupled into the fiber core can thus be increased, for example, by enlarging the transfer means, or by increasing the number of transfer means.

Optionally, the plurality of transfer means may be spaced apart, in particular spaced apart over the circumference of the windings or loops of the loop-like wound optical fiber. This can then leave space between the transfer means which can be used for example for optimally winding the optical fiber.

The at least one transfer means may include a recess for passage of the optical fiber. In this case, at least one transfer means can surround the optical fiber along partial lengths. When the gaps between the material of the transfer means in the region of the openings and of the optical fiber are as small as possible, the pump light can be coupled from the transfer means into the optical fiber with relatively little disruption. In a preferred embodiment of the fiber laser device, this coupling is improved by making the refractive index of the at least one transfer means substantially equal to the refractive index of the optical fiber, and in particular substantially equal to the refractive index of the fiber core. Optionally, a plurality of recesses may be provided.

The at least one transfer means, and in particular each of the transfer means, may be composed of two parts, preferably two halves, or may consist or two parts, preferably two halves. The two parts may have mutually corresponding recesses for the passage of the optical fiber. With such a configuration, a fiber laser device according to the invention can be relatively easily constructed, since the two parts need only be placed around the optical fiber and connected, for example glued together.

Optionally, the at least one transfer means may be configured such that the pump light coupled in during the operation of the fiber laser device experiences at least one reflection, preferably multiple reflections, in the at least one transfer means, thereby increasing the pumping efficiency. The pump light coupled into the transfer means is then utilized more effectively.

A semiconductor laser or a plurality of semiconductor lasers, such as a laser diode bar or stack of laser diode bars can be used as the pump light source. The laser light from this semiconductor laser or from these semiconductor lasers can be collimated with appropriate optics and introduced into the at least one transfer means.

The fiber core may be made, for example, of glass, preferably of quartz glass. The fiber core may be doped with laser-active rare earth ions, such as ytterbium, neodymium or erbium ions.

For example, a fiber laser doped with ytterbium ions can be operated with a pump wavelength of 975 nm and an output wavelength of 1060 nm.

For example, one end of the fiber core may be made highly reflective, for example with a reflectivity of approximately 100%, while the other end of the fiber core is used for coupling the laser beam out. This other end can then have a lower reflectivity for coupling the laser light out.

The fiber laser device may be designed such that, during operation of the fiber laser device, the pump light is coupled into the at least one transfer means at an angle. With this angle, multiple reflections of the pump light in the at least one transfer means are ensured, thereby increasing the pumping efficiency. The pump light coupled into the transfer means light is then utilized more effectively. This angle in conjunction with the divergence of the pump beam are meant to ensure that the beam hits the zone of the at least one optical fiber or of the bundle of optical fibers or of the loops of the at least one optical fiber in the at least one transfer means.

The inside diameter of the at least one opening in the at least one transfer means may be substantially equal to the outside diameter of the optical fiber, preferably the inner diameter of the at least one opening may be larger by less than 50 μm, especially by less than 30 μm, for example by between 10 μm and 20 μm than the outside diameter of the optical fiber. With this comparatively small gap between the optical fiber and the transfer means, the pump light can enter from the transfer means into the optical fiber relatively unimpeded or without additional reflections or refractions.

Alternatively or in addition, the inner diameter of the at least one opening in the at least one transfer means may correspond substantially to the outer diameter of the optical fiber or of the bundle of optical fibers or of the plurality of loops of the optical fiber. Due to this very small gap between the optical fiber and the transfer means, the pump light can enter from the transfer means into the optical fiber relatively unimpeded or without additional reflections or refractions.

The at least one transfer means may have a region, in particular a window or an entrance face for entry of the pump light, wherein this region is significantly smaller than the at least one highly reflective region.

The following relationship may apply to the ratio q=d_{L}/d₀ between the diameter d_{L} of the at least one optical fiber or of the bundle of optical fibers or of the loops of the at least one optical fiber transfer means, and the diameter d₀ of the at least one transfer means:

0.01<q<1.0, in particular 0.05<q<0.5, and for example q=0.1. q may also be less than 0.01.

By employing such a measure, the pump light is in the interior of the transfer means incident on the optical fiber as often as possible which increases the pumping efficiency.

The fiber laser device may include one or more optical fibers.

Additional features and advantages of the present invention will become apparent from the following description of preferred embodiments with reference to the accompanying drawings, which show in:

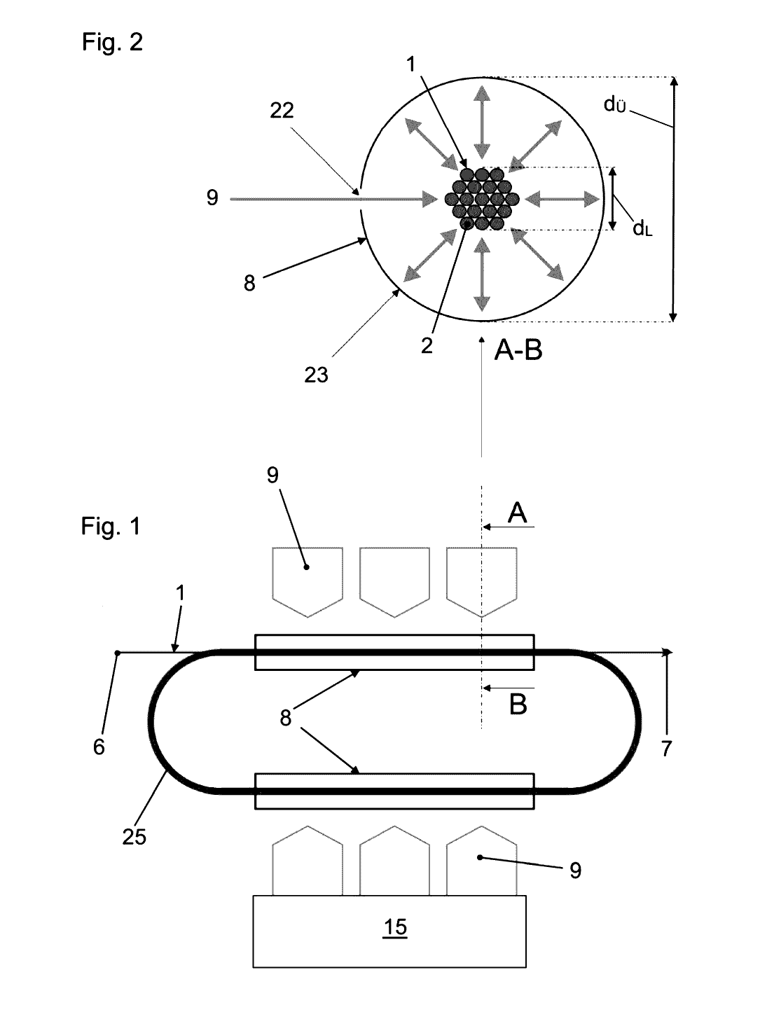

FIG. 1 a plan view of a first embodiment of fiber laser device according to the invention;

FIG. 2 an enlarged, schematic cross-section according to the arrows A, B in FIG. 1;

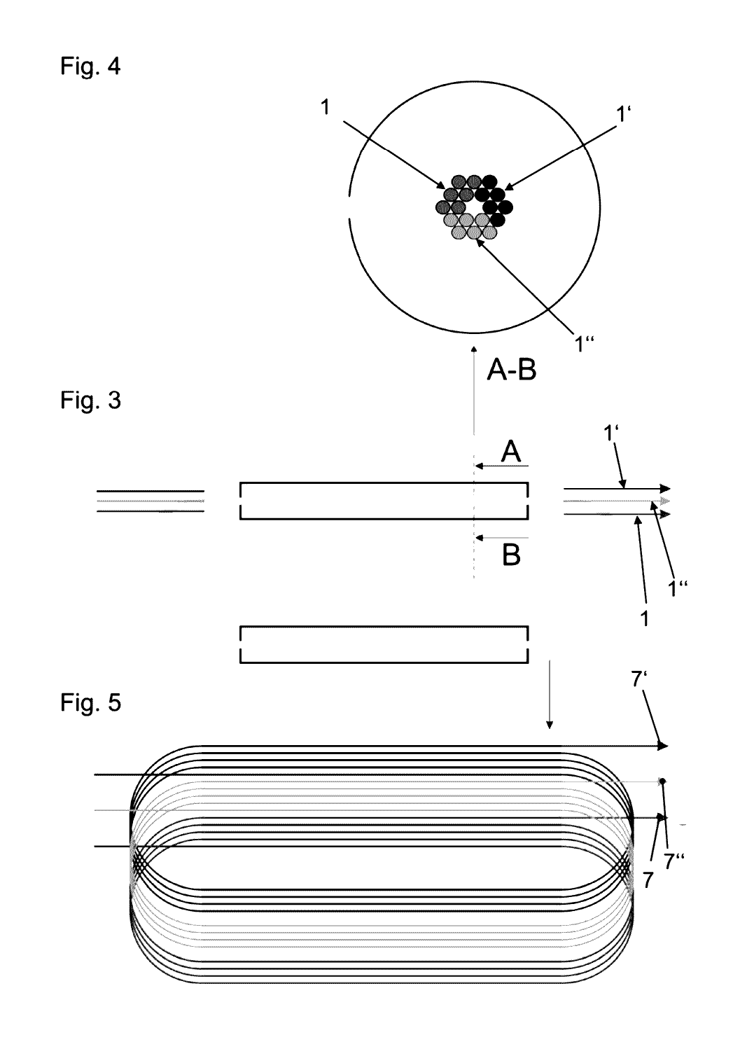

FIG. 3 a plan view of a second embodiment of a fiber laser device according to the invention;

FIG. 4 an enlarged, schematic cross-section according to the arrows A, B in FIG. 3;

FIG. 5 a detailed view of the second embodiment shown in FIG. 3;

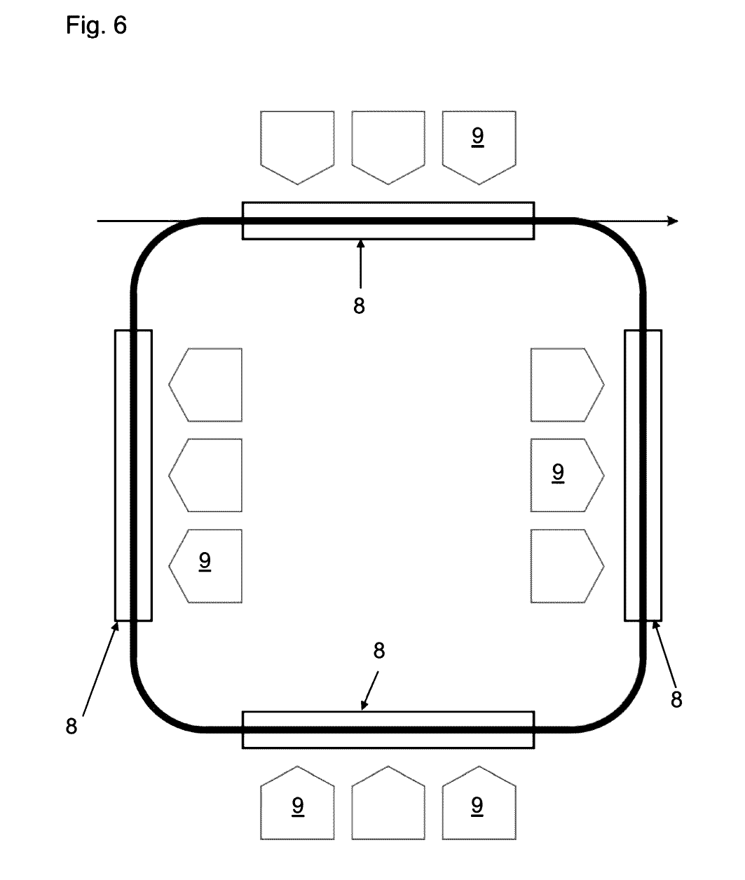

FIG. 6 a plan view of a third embodiment of a fiber laser device according to the invention;

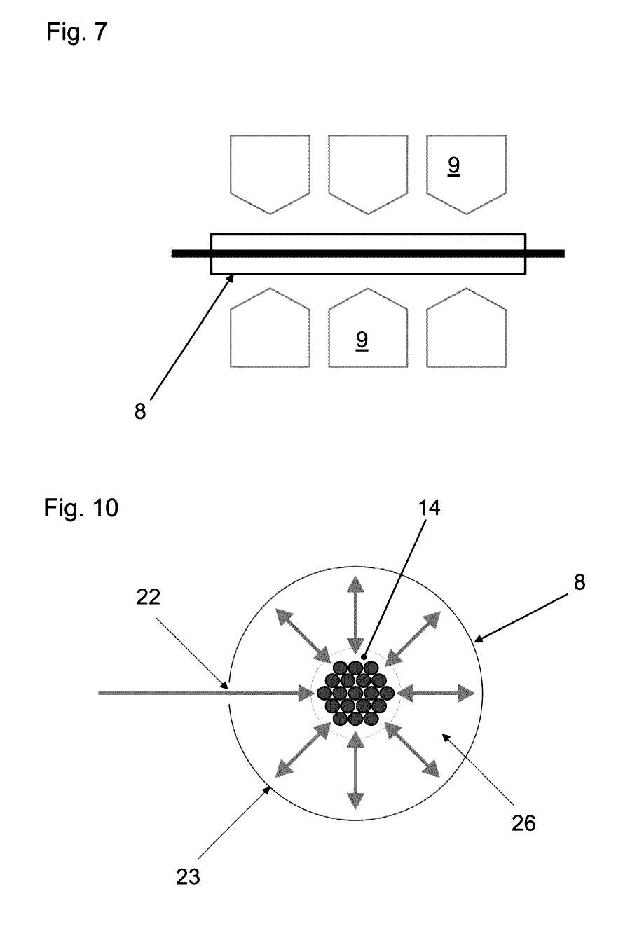

FIG. 7 a detailed view of a fourth embodiment of a fiber laser device according to the invention;

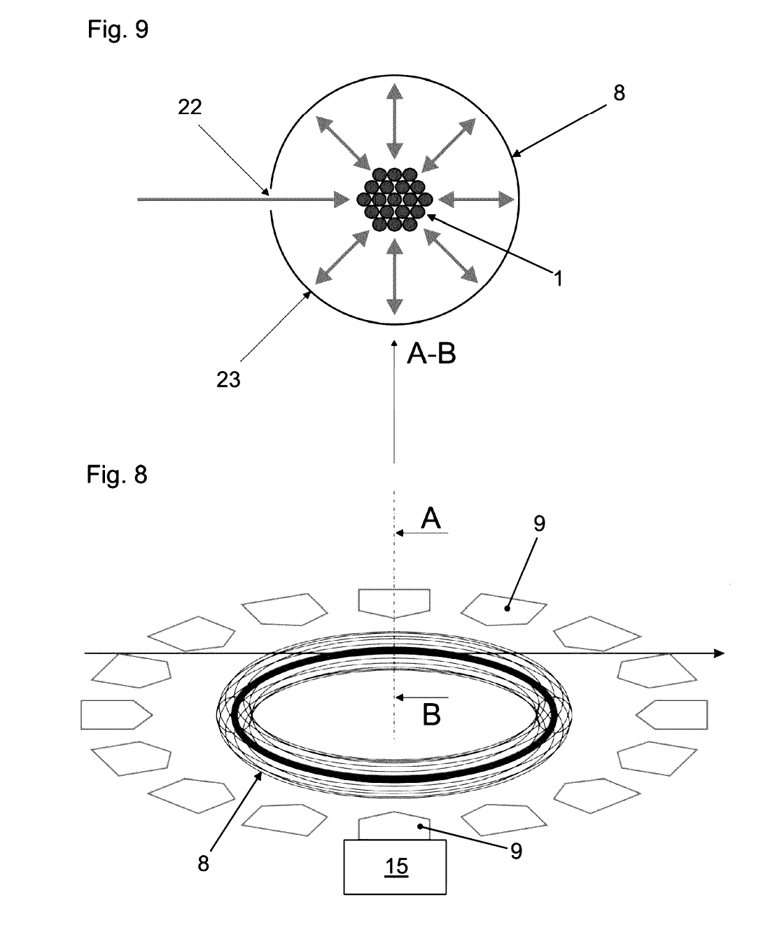

FIG. 8 a plan view of a fifth embodiment of a fiber laser device according to the invention;

FIG. 9 an enlarged, schematic cross-section according to the arrows A, B in FIG. 8;

FIG. 10 a detailed view of a sixth embodiment of a fiber laser device according to the invention;

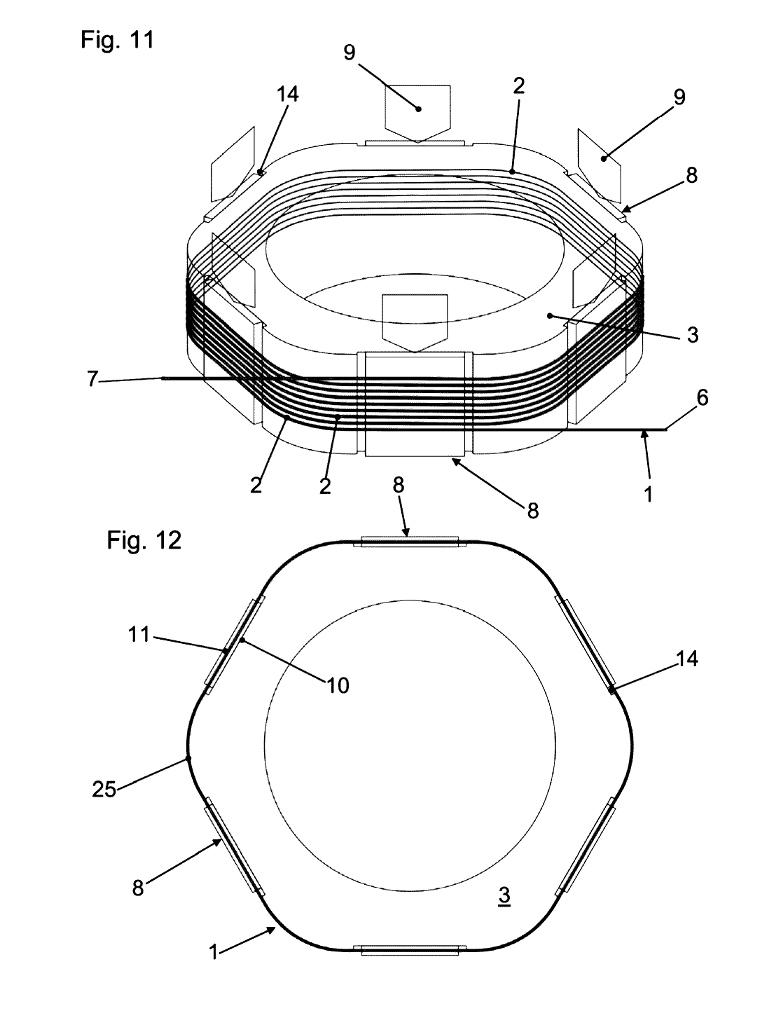

FIG. 11 a schematic perspective view of a seventh embodiment of a fiber laser device according to the invention;

FIG. 12 a plan view of the embodiment shown in FIG. 11;

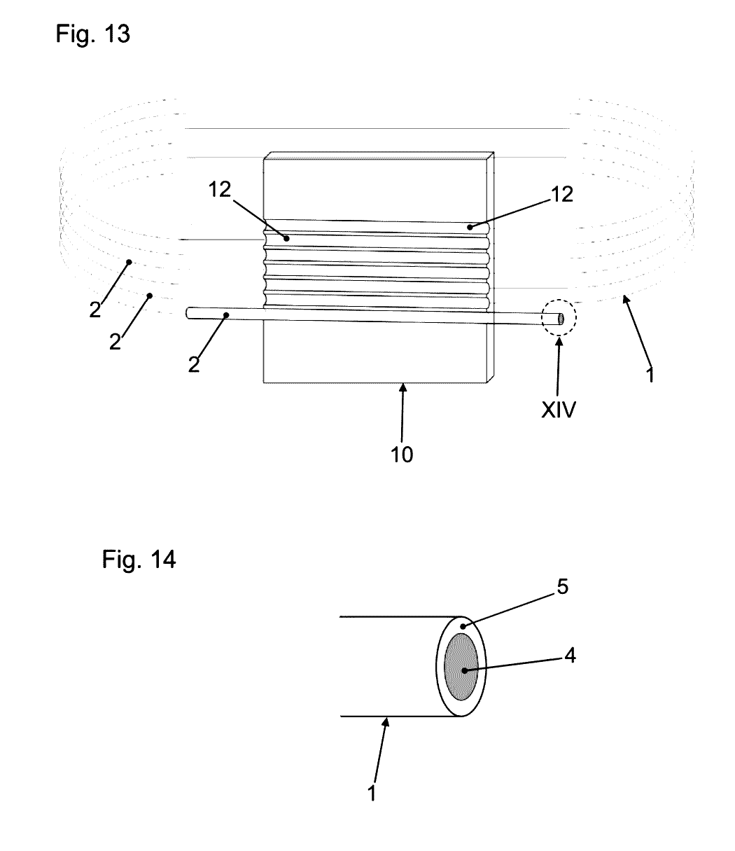

FIG. 13 a detailed schematic view of the embodiment of FIG. 11;

FIG. 14 a detail according to the arrow XIV in FIG. 13, which illustrates the structure of an optical fiber of a fiber laser device according to the invention;

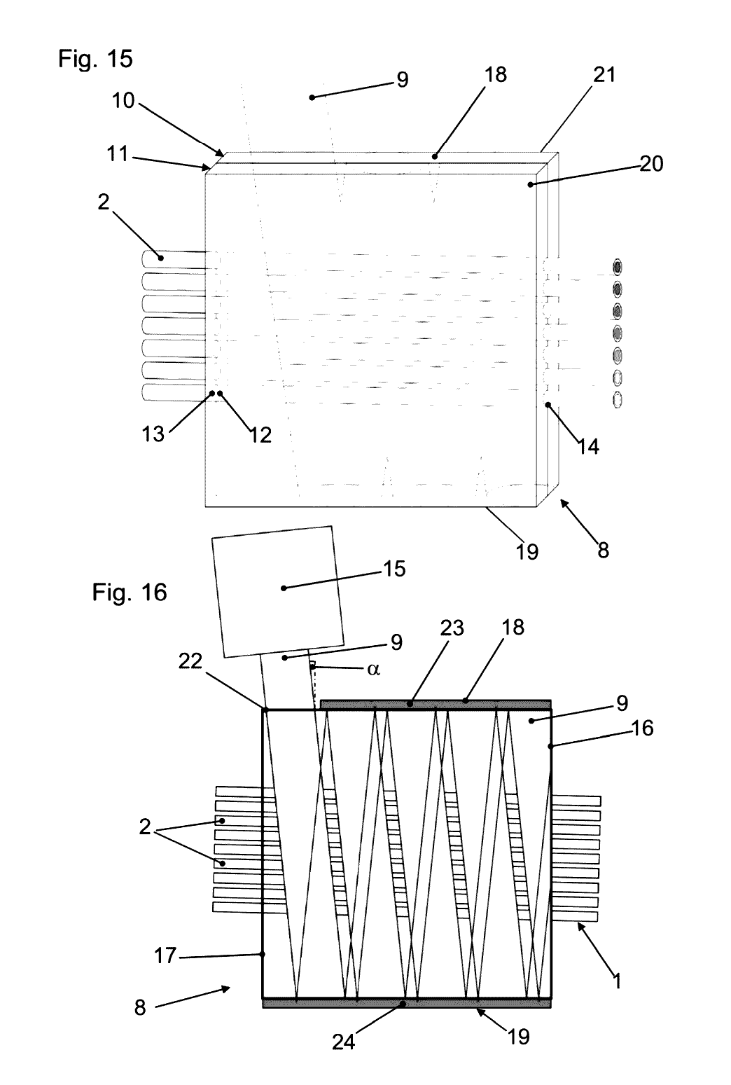

FIG. 15 a perspective view of a transfer means of the seventh embodiment of a fiber laser device according to the invention with loops of the optical fiber passing through the transfer means;

FIG. 16 a schematic side view of a transfer means of the seventh embodiment of a fiber laser device according to the invention with loops of the optical fiber passing through the transfer means and with schematically indicated pump means.

Identical or functionally identical parts in the figures are provided with identical reference symbols.

The exemplary embodiment of a fiber laser device according to the invention shown in FIG. 1 and FIG. 2 includes an optical fiber 1 which is wound in a plurality of loops or windings 2. The loops 2 extend in such a way that they are closely packed as shown in FIG. 2, wherein the dense packing of the individual loops 2 of the optical fiber 1 has a substantially circular contour with a diameter d_{L}.

In FIG. 2, 19 loops 2 are indicated. However, a lesser or greater number of loops may be provided.

The optical fiber 1 has a fiber core 4 and a cladding 5 surrounding the fiber core 4 (see FIG. 14). The cladding 5 has typically a somewhat lower refractive index than the fiber core 4 so that light can be guided in the fiber core 4 by total internal reflection. The difference in refractive index between the fiber core 4 and the cladding 5 may, for example, be 0.003 for an NA=0.1.

The fiber core 4 is made of a laser active material or includes a laser-active material. For example, the fiber core 4 may be made of glass doped with rare earth ions, such as ytterbium, neodymium or erbium ions. The glass may be fused silica. In this case, the cladding 5 may also be made of glass, especially of quartz glass.

The fiber core 4 may have a diameter from several μm (single mode) up to 1000 μm and more (for example, 100 μm). The cladding 5 has generally a smaller thickness than the fiber core (for example, 10 μm for the cladding and 100 μm for the fiber core). The thickness of the cladding should be as small as possible for technological reasons.

Both ends 6, 7 of the optical fiber 1 are provided with a coating in the region of the fiber core 4, so that for example the left end 6 in FIG. 1 is highly reflective, for example 99.8%. Furthermore, the right end 7 of the optical fiber 1 in FIG. 1 can serve as the output coupler and have a lower reflectivity. However, both ends 6, 7 of the optical fiber 1 may also be configured to allow laser radiation to be coupled out at the ends 6, 7.

The illustrated embodiments of the fiber laser device according to the invention furthermore include two transfer means 8 configured to couple pump light 9 schematically indicated in FIG. 1 into the optical fiber 1. However, a greater or smaller number of transfer means 8 may be provided.

In the illustrated exemplary embodiment, pump light 9 is introduced into each of the transfer means 8 from one side. For this purpose, each of the transfer means 8 has a window 22 or an entrance face through which the pump light 9 can enter into the transfer means 8.

Alternatively, pump light 9 may enter into the transfer means 8 from two directions, as is indicated in FIG. 7. In this case, two windows 22 or entrance faces are located on opposite sides of the transfer means 8.

The transfer means 8 are mutually spaced apart in the circumferential direction of the loops 2. The loops 2 of the light guide 1 in the embodiments shown in FIG. 1 to FIG. 7 extend in the region of the transfer means 8 linearly, whereas they have a curvature 25 in the circumferential direction in the region between the transfer means 8 (see FIG. 1).

The transfer means 8 may each consist of two parts, which correspond to one another and in particular are each formed as identical or mirror-image halves of the respective transfer means 8. However, the parts may also be different from each other, wherein for example one of the parts may be thicker, higher or wider than the other of the parts.

Furthermore, the transfer means 8 may also be formed as a single piece.

Each of the transfer means has a cylindrical shape, wherein the lateral surface, with the exception of the window 22 and the entrance face has a high reflectivity, for example, a highly reflective coating 23. In particular, the window 22 or the entrance face may extend in the axial direction over the entire length of the transfer means 8. The purpose of the transfer means 8 is to guarantee a high pump power in the zone where the optical fiber is located. The dimension of the transfer means 8 in the circumferential direction must be several times (1-10 times, or even more) greater than the diameter d_{L} of the at least one optical fiber 1 or of the bundle of optical fibers 1 or of several loops 2 of the at least one optical fiber 1. The length of the transfer means 8 in the axial direction corresponds to the entire length of the pump beam, and can vary over a wide range of a few mm and more. For example, the length of the transfer means 8 in the axial direction may be 100 mm when pumping with laser diode bars arranged in a row.

Each of the transfer means 8 may be formed as a substrate of a transparent material, such as quartz, and may have the same refractive index as the optical fiber 1, in particular the fiber core 4 or the cladding 5 of the optical fiber 1.

The transfer means 8 may have a closed hollow-cylindrical receptacle 14 in which the loops 2 of the optical fiber 1 are arranged (see FIG. 10). The inner diameter of the receptacle 14 may hereby correspond substantially to the diameter d_{L} of the dense packing of the individual loops 2 of the optical fiber 1. The dense packing is not necessarily arranged in the center of the receptacle 14. The transfer means 8 may not necessarily have a circular cross-section. For example, the transfer means 8 may have an elliptical cross-section, wherein the bundle of the optical fibers is located in a focal point of the ellipse, whereas the pump light is focused onto this focal point or onto the second focal point. Even when the cross section of the transfer means 8 is circular, the bundle need not necessarily be arranged in the center, but may have a spacing from the center, wherein the pump light should be focused onto the bundle or onto the center of the circle.

Alternatively, a hollow cylinder may be used as a transfer means, with the dense packing of the individual loops 2 of the optical fiber 1 extending in its center. The inner lateral surface is highly reflective, with the exception of a window 22.

When the transfer means 8 are constructed in two parts, the two parts can each have a recess on the side facing the other part, which extends in the circumferential direction of the optical fiber 1 and has in particular a semi-hollow-cylindrical shape. The recesses of the parts then complement each other to the closed hollow-cylindrical opening 14 which surrounds the loops 2 of the optical fiber 1.

FIG. 1 schematically indicates pump means 15. These may include as pump light source a semiconductor laser or a plurality of semiconductor lasers, such as a laser diode bar or a stack of laser diode bars. The laser light from this semiconductor laser or from this plurality of semiconductor lasers serving as pump light 9 can be collimated with suitable optics and can be coupled into the at least one transfer means 8. Due to the elongated window 22, the pump light 9 should have a line-shaped intensity distribution that extends in the axial direction of the transfer means 8. Ideally, when entering into the transfer means 8, the intensity distribution has in the direction perpendicular to the line a width that corresponds to the width of the window 22, i.e. in particular, for example, about 100 μm. Furthermore, the intensity distribution ideally has, when entering into the transfer means 8, in the longitudinal direction of the line a length that corresponds to the length of the transfer means 8, here in particular for example about 100 mm.

The fiber laser device is designed so that the pump light 9 enters the transfer means 8 in the radial direction during the operation of the fiber laser device (see FIG. 2). The deviation from the entrance normal is thus ideally α=0°. The reflective coatings 23 and the aforementioned angle α cause the pump light 9 entering through the window 22 or the entrance face to be repeatedly reflected back and forth in the interior of the transfer means 8. In this way, the pump light 9 passes very frequently through the loops 2 of the light guide 1, so that pump light 9 can be very effectively introduced into the individual loops 2 of the optical fiber 1 and, in particular, the fiber core 4.

As it turns out, in particular the ratio q=d_{L}/d₀ between the diameter d_{L} of at least one optical fiber 1 or of the bundle of optical fibers 1 or the loops 2 of the at least one optical fiber 1 in the at least one transfer means 8 and the diameter d₀ of the at least one transfer means 8 is essential for the effectiveness of the fiber laser (see FIG. 2). Advantageously, the ratio may be greater than 0.01 and less than 1.0, preferably less than 0.5, for example equal to 0.1.

For example, the diameter d_{L} of the at least one optical fiber 1 or of the bundle of optical fibers or of one of the loops 2 of the at least one optical fiber 1 may be about 1 mm to 2 mm. Furthermore, the diameter d₀ of the at least one transfer means 8 may be about 8 mm.

In the embodiment shown in FIG. 3 to FIG. 5, three different optical fibers 1, 1′, 1″ are combined into a bundle of optical fibers or loops 2, 2′, 2″ of optical fibers. This produces three ends 7, 7′, 7″ of the optical fibers serving as output couplers.

More or less than three optical fibers 1, 1′, 1″ may be combined into a bundle.

In the embodiment shown in FIG. 6, four transfer means 8 are provided.

In the embodiment of FIG. 8 and FIG. 9, the loops 2 of the optical fiber 1 are circular, so that no linear sections exist. Therefore, a single circumferential toroidal transfer means 8 is provided. FIG. 8 also indicates schematically individual pump means 15. More pump means 15 than shown may be provided.

The seventh exemplary embodiment of a fiber laser device according to the invention shown in FIGS. 11 to 16 includes an optical fiber 1, which is wound onto a coil-shaped holder 3 in a plurality of loops 2 or windings. The loops 2 extend hereby on the holder 3 so that they are each arranged above one another with a mutual constant spacing in the axial direction of the holder 3 or in the vertical direction in FIG. 11.

In FIG. 11 and FIG. 16, nine loops 2 are indicated, whereas seven loops 2 are indicated in FIG. 13 and FIG. 15. Optionally, a lesser number of loops, for example two or three or four loops, or even more loops, for example 10 or 11 or 12 or more loops, may be provided.

The optical fiber 1 has a fiber core 4 and a cladding 5 surrounding the fiber core 4 (see FIG. 14). In conventional manner, the cladding 5 has a somewhat lower refractive index than the fiber core 4 so that light can be guided in the fiber core 4 by total internal reflection. The difference in the refractive index between the cladding 5 and the fiber core 4 may for, example be on the order of about 0.003.

The fiber core 4 consists of a laser-active material or includes a laser-active material. For example, the fiber core 4 is made of glass doped with the rare earth ions, such as ytterbium, neodymium or erbium ions. The glass may be quartz glass. The cladding 5 may also be made of glass, especially of quartz glass.

The two ends 6, 7 of the optical fiber 1 are provided with a coating in the region of the fiber core 4 so that for example the right end 6 in FIG. 11 is highly reflective, for example in a range between 99% and 100%. Furthermore, the left end 7 of the optical fiber 1 in FIG. 11 can serve as an output coupler and have a lower reflectivity. However, alternatively both ends 6, 7 of the optical fiber 1 may be configured such that laser radiation can be coupled out therefrom.

The illustrated embodiments of the fiber laser device according to the invention furthermore include a plurality of transfer means 8, through which the pump light 9 schematically indicated in FIG. 11 can be coupled into the optical fiber 1. In the illustrated exemplary embodiments, six transfer means 8 are provided. However, a greater or lesser number of transfer means 8 may be provided.

The transfer means 8 are spaced apart in the circumferential direction of the holder 3. The loops 2 of the optical fiber 1 each extend linearly in the region of the transfer means 8, whereas they have a curvature 25 in the circumferential direction in the region between the transfer means 8 (see FIG. 12).

As can be seen from FIG. 13 and FIG. 15, the transfer means 8 are each constructed of two parts 10, 11 which in particular correspond to each other and are formed as identical or mirror-inverted halves of the respective transfer means 8. However, the parts 10, 11 may also be different from each other, wherein for example one of the parts 10, 11 may be thicker, higher or wider than the other of the parts 10, 11. Furthermore, the parts may also have different other properties, like the arrangement of reflective coatings which will be described in greater detail below.

Each of the parts 10, 11 has on its side facing the other part 10, 11 a plurality of recesses 12, 13 which extend in the circumferential direction of the optical fiber 1 and have in particular a semi-hollow-cylindrical shape. The respective recesses 12, 13 of the parts 10, 11 arranged at the same height of the parts 10, 11 of the transfer means 8 form in combination a closed hollow cylindrical opening 14 which surrounds one of the loops 2 of the optical fibers 1. The loops 2 of the optical fibers 1 thus extend in the region of the transfer means 8 in the interior of these transfer means 8 (see FIG. 15).

The recesses 12, 13 are especially designed so that their inside diameter corresponds almost exactly to the outside diameter of the optical fiber 1. In particular, the deviation between the inside diameter of the recesses 12, 13 and the outer diameter of the optical fiber 1 is less than 50 μm, in particular less than 30 μm, for example between 10 μm and 20 μm. The parts 10, 11 of the transfer means 8 may have the same refractive index as the optical fiber 1, in particular the fiber core 4 or the cladding 5 of the optical fiber 1. For example, the parts 10, 11 of the transfer means 8 may be made of glass, in particular of quartz glass.

The holder 3 has in particular the region of the transfer means 8 an inwardly projecting setback 14 in which a part 10 of the transfer means 8 is arranged (see FIG. 11 and FIG. 12). This ensures that the optical fiber 1 extends from the region between the transfer means 8 into the respective transfer means 8 without a radial offset (see FIG. 12).

FIG. 16 schematically indicates pump means 15. These may include as a pump light source a semiconductor laser or a plurality of semiconductor lasers, such as a laser diode bar or a stack of laser diode bars. The laser light from this semiconductor laser or from these semiconductor lasers serving as pump light 9 can be collimated with suitable optics and coupled into the at least one transfer means 8.

The embodiment of a transfer means 8 illustrated in FIG. 15 and FIG. 16 has a flat, rectangular shape. The transfer means 8 has two lateral end faces 16, 17 for entry and exit of the loops 2 of the optical fiber 1. Furthermore, the transfer means 8 has an upper end face 18, 19 in FIG. 15 and FIG. 16, and a lower end face 18, 19 in FIG. 15 and FIG. 16. Furthermore, the transfer means 8 has a flat front side 20 in FIG. 15 and a flat rear side 21 in FIG. 15.

The top end face 18 in FIG. 15 and FIG. 16 is provided with a reflective coating 23, with the exception of a small section serving as an entrance face 22 for the pump light 9. The bottom end face 19 in FIG. 15 and FIG. 16 is completely provided with a reflective coating 24.

In addition to the upper and lower end faces 18, 19 in FIG. 15 and FIG. 16, additional sides, for example the left and right end faces 16, 17 shown in FIG. 15 and FIG. 16 or the front and rear flat sides 20, 21 shown in FIG. 15 and FIG. 16, may be provided with reflective coatings.

The fiber laser, device is designed so that during the operation of the fiber laser device the pump light 9 is coupled into the at least one transfer means 8 at an angle α, for example at an angle α between 5° and 10° perpendicular to the normal of the entrance face 22. The reflective coatings 23, 24 and the aforementioned angle α cause the pump light 9 entering through the entrance face 22 to be repeatedly reflected back and forth in the interior of the transfer means 8 between the lower end face 18, 19 in FIG. 15 and FIG. 16 and the upper face 18, 19 in FIG. 15 and FIG. 16. In this way, the pump light 9 passes several times through the loops 2 of the light guide 1.

FIG. 15 shows that the light bundle of the pump light 9 incident on the entrance face 22 covers the entire depth of the entrance face 22 in the radial direction of the holder 3 and/or in the direction extending into the drawing plane of FIG. 15 and FIG. 16. Because the transfer means 8 and the optical fiber 1 have substantially identical refractive indexes, the pump light 9 can propagate relatively freely in the interior of the transfer means 8, so that the individual loops 2 of the optical fiber 1 and the pump light 9 can be very effectively introduced in particular into the fiber core 4.

1. A fiber laser device, comprising
an optical fiber (1) having a fiber core (4), which is composed of a laser-active material, or comprises a laser-active material, wherein the optical fiber (1) is wound in the shape of a loop,
a pump (15) for optical pumping of the fiber core (4) with pump light (9),
wherein the pump (15) is designed such that the pump light (9) enters into the optical fiber (1) during operation of the fiber laser device laterally from the outside.

2. The fiber laser device according to claim 1, wherein the pump (15) comprises at least one transfer device (8), into which pump light (9) is introduced during the operation of the fiber laser device and from which or in which the pump light (9) is coupled into the at least one optical fiber (1) and wherein the least one transfer device (8) or each of the transfer devices (8) has an opening (14) or a cavity for the passage of a bundle of optical fibers (1) or of several loops (2) of the at least one optical fiber (1).

3. The fiber laser device according to claim 1, wherein the pump (15) is configured such that during the operation of the fiber laser device several windings or loops (2) of the loop-like wound optical fiber (1) are pumped simultaneously.

4. The fiber laser device according to claim 1, wherein the pump (15) comprises at least one transfer device (8), into which pump light (9) is coupled during the operation of the fiber laser device and from which the pump light (9) is coupled into the optical fiber (1).

5. The fiber laser device according to claim 1, wherein the pump (15) comprises several transfer devices (8) spaced apart from one another.

6. The fiber laser device according to claim 2, wherein the at least one transfer device (8) includes at least one recess (12, 13) for the passage of the optical fiber (1).

7. The fiber laser device according to claim 2, wherein the at least one transfer device (8) has an opening (14) or a cavity for the passage of the optical fiber (1) or of a bundle of optical fibers (1) or of several loops (2) of the optical fiber (1).

8. The fiber laser device according to claim 2, wherein the at least one transfer device (8) surrounds the optical fiber (1) along partial lengths.

9. The fiber laser device according to claim 2, wherein the at least one transfer device (8) surrounds the bundles of optical fibers (1) or several loops (2) of the optical fiber (1) along partial lengths.

10. The fiber laser device according to claim 2, wherein the refractive index of the at least one transfer device (8) is substantially identical to the refractive index of the optical fiber (1).

11. The fiber laser device according to claim 2, wherein the at least one transfer device (8) comprises a substrate or is composed of a substrate through which the pump light (9) passes.

12. The fiber laser device according to claim 2, wherein the refractive index of the substrate of the at least one transfer device (8) is substantially identical to the refractive index of the optical fiber (1).

13. The fiber laser device according to claim 2, wherein the at least one transfer device (8) is at least partially hollow.

14. The fiber laser device according to claim 2, wherein the at least one transfer device (8) is formed in one piece.

15. The fiber laser device according to claim 2, wherein the at least one transfer device (8) is composed of two parts.

16. The fiber laser device according to claim 15, wherein the two parts have mutually corresponding recesses (12, 13) for the passage of the optical fiber (1).

17. The fiber laser device according to claim 15, wherein the two parts have mutually corresponding recesses for the passage of the bundle of optical fibers (1) or of several loops (2) of the optical fiber (1).

18. The fiber laser device according to claim 2, wherein the at least one transfer device (8) is designed such that the pump light (9) coupled in during the operation of the fiber laser device experiences at least one reflection.

19. The fiber laser device according to claim 2, wherein the at least one transfer device (8) has at least one highly reflective region.

20. The fiber laser device according to claim 2, wherein the fiber laser device designed such that the pump light (9) is coupled into the at least one transfer device (8) at an angle (α) during the operation of the fiber laser device.

21. The fiber laser device according to claim 19, wherein the at least one transfer device (8) has a region for entry of the pump light (9), wherein this region is significantly smaller than the at least one highly reflective region.

22. The fiber laser device according to claim 2, wherein the inside diameter of the at least one recess (12, 13) in the at least one transfer device (8) corresponds substantially to the outside diameter of the optical fiber (1).

23. The fiber laser device according to claim 2, wherein the inside diameter of the at least one opening (14) in the at least one transfer device (8) corresponds substantially to the outside diameter (d_{L}) of the optical fiber (1) or of the bundle of optical fibers (1) or of the several loops (2) of the optical fiber (1).

24. The fiber laser device according to claim 2, wherein the following relationship holds for the ratio q=d_{L}/d₀ between
the diameter (d_{L}) of the optical fiber (1) or of the bundle of optical fibers (1) or of the loops (2) of the at least one optical fiber (1) in the at least one transfer device (8) and
the diameter (d₀) of the at least one transfer device (8) is 0.01<q<1.0.

25. The fiber laser device according to claim 1, wherein the fiber laser device comprises one or more optical fibers (1, 1′, 1″).

26. The fiber laser device according to claim 1, wherein the pump (15) comprises at least one transfer device (8) into which pump light (9) is introduced during the operation of the fiber laser device and from which or in which the pump light (9) is coupled into the at least one optical fiber (1), wherein the at least one transfer device (8) surrounds at least along partial lengths the at least one optical fiber (1) or the bundle of optical fibers (1) or the several loops (2) of the at least one optical fiber (1), wherein the at least one transfer device (8) has a cylindrical shape and wherein the fiber laser device is designed such that, during the operation of the fiber laser device, the pump light (9) is coupled into the at least one transfer device (8) in the radial direction of the at least one cylindrical transfer device (8) or at an angle (α) smaller than 90°.

27. The fiber laser device according to claim 4, wherein the pump (15) comprises several transfer devices (8), into which pump light (9) is coupled during the operation of the fiber laser device and from which the pump light (9) is coupled into the optical fiber (1).

28. The fiber laser device according to claim 5, the several transfer devices (8) are spaced apart from one another over the circumference of the windings or loops (2) of the loop-like wound optical fiber (1).

29. The fiber laser device according to claim 6, wherein the at least one transfer device (8) includes a plurality of recesses (12, 13) for the passage of the optical fiber (1).

30. The fiber laser device according to claim 10, wherein the refractive index of the at least one transfer device (8) is substantially equal to the refractive index of the fiber core (4).

31. The fiber laser device according to claim 12, wherein the refractive index of the substrate of the at least one transfer device (8) is substantially identical to the refractive index of the fiber core (4).

32. The fiber laser device according to claim 15, wherein the at least one transfer device (8) comprises two parts formed as two halves.

33. The fiber laser device according to claim 18, wherein the at least one reflection comprises multiple reflections in the at least one transfer device (8), for increasing pumping efficiency.

34. The fiber device according to claim 19 the at least one highly reflective region includes a highly reflective coating (23).

35. The fiber laser device according to claim 21, wherein the at least one transfer device (8) has a region entry of the pump light (9), wherein this region is significantly smaller than the at least one highly reflective region.

36. The fiber laser device according to claim 22, wherein the inside diameter of the at least one recess (12, 13) is larger than the outside diameter of the optical fiber (1) by less than 50 μm.

37. The fiber laser device according to claim 36, wherein the inside diameter of the at least one recess (12, 13) is larger than the outside diameter of the optical fiber (1) by less than 30 μm, for example by between 10 μm and 20 μm.

38. The fiber laser device according to claim 26, wherein the angle (α) is smaller than 30° with respect to the radial direction.
